(19) United States
(12) Patent Application Publication
(10) Pub. No.: US 2010/0328271 A1
(43) Pub. Date: Dec. 30, 2010

(54) METHOD AND APPARATUS FOR GENERATING DRIVER SIGNALS OF SAW TOUCH PANEL

(76) Inventors: Shang-Tai YEH, Taipei City (TW); Teng-Wei HSIEH, Taipei City (TW)

Correspondence Address: HDLS Patent & Trademark Services, P.O. BOX 220746, CHANTILLY, VA, 20153-0746, US

(21) Appl. No.: 12/492,185

(22) Filed: Jun. 26, 2009

(51) Int. Cl. G06F 3/043

(52) U.S. Cl. 345/177

(57) ABSTRACT

The present invention relates to a method and apparatus for generating driver signals of SAW touch panel. The method includes the steps of: sending a trigger signal continuously by referring to an input signal, wherein the trigger signal is sent when the input signal is within a predetermined range; generating a surface acoustic wave according to the trigger signal; transmitting the surface acoustic wave to at least one transducer via a touch surface; and detecting the input signal via at least one transducer. Moreover, the input signal is kept on a predetermined level when the surface acoustic wave has not been received by the transducer and when a noise signal from circuits outside the transducer has not been added in the input signal. The predetermined level is within the predetermined range. The sensing accuracy of the SAW touch panel can be enhanced because the noise signal has less effect on the driver signals.

### BACKGROUND OF THE INVENTION

1. Field of the Invention

The present invention relates to a method and apparatus for generating driver signals of SAW touch panel, and in particular to a method and apparatus for generating driver signals of SAW touch panel, whereby the interference of noise signals can be prevented.

2. Background of Invention

Touch panel is widely used in many electronic products. The touch panel can be categorized into many types, such as resistive, capacitive, surface acoustic wave, infrared, electromagnetic etc. Among the above-mentioned types of touch panels, the surface acoustic wave (referred to as “SAW” hereinafter) touch panel is superior in light transmittance, fire resistance, durability, and quality of image. Therefore, the SAW touch panel is widely used in various electronic products.

Please refer to FIG. 1, which is a top view of a conventional SAW touch panel. Please also refer to FIG. 2, which is a perspective view of the conventional SAW touch panel. The conventional SAW touch panel comprises a working surface 104, a first side surface 106, a second side surface 108, a third side surface 110, a fourth side surface 112, an X-axis transmitting transducer 114, an X-axis receiving transducer 116, a Y-axis transmitting transducer 124, a Y-axis receiving transducer 126, and a plurality of reflective stripes 190, 191, 192 and 193 that are arranged sparsely and densely in an alternating manner. These transducers 114, 116, 124 and 126 are devices for converting mechanical energy into electric energy (or vice versa) via the piezoelectric effect.

The surface wave generated by the X-axis transmitting transducer 114 is reflected by the reflective stripe 193 and propagates towards the positive X direction. Then, the surface wave is reflected by the reflective stripe 191 and propagates toward the positive Y direction. Finally, the surface wave is received by the X-axis receiving transducer 116 and converted into electric energy. Similarly, the surface wave generated by the Y-axis transmitting transducer 124 is reflected by the reflective stripe 192 and propagates towards the positive Y direction. Then, the surface wave is reflected by the reflective stripe 190 and propagates toward the positive X direction. Finally, the surface wave is received by the Y-axis receiving transducer 126 and converted into electric energy

The X axis is taken as an example. Please refer to FIGS. 3 and 4. FIG. 3 shows the voltage waveform generated by the X-axis receiving transducer 116 when the touch panel has not been touched by an object. FIG. 4 shows the voltage waveform generated by the X-axis receiving transducer 116 when the touch panel has been touched by an object. As seen in FIG. 4, since the object touches the panel and thus absorbs some surface acoustic wave energy, an indentation is formed in the voltage waveform. The traveling distances of the surface waves reflected by different reflective stripes 191 and 193 are not the same, which can be used to determine the touch point in Y axis. In this way, the location of the touch point can be determined.

The SAW touch panel has many advantageous features and is widely used, however, like other electronic products, noise signals of different frequencies exist in the circuit of the real SAW touch panel, and these noise signals may come from a power-supplying end. The noise signals will spread all over in the circuit of the SAW touch panel, so that the performance and accuracy of the SAW touch panel will be deteriorated. Therefore, it is an important issue to propose a method and apparatus for generating driver signals of SAW touch panel, thereby preventing the interference of noise signals and increasing the sensing accuracy of the SAW touch panel.

### SUMMARY OF THE INVENTION

In order to solve the drawbacks of prior art, the present invention provides a method for generating driver signals of SAW touch panel, thereby increasing the sensing accuracy of the SAW touch panel.

In order to solve the drawbacks of prior art, the present invention provides an apparatus for generating driver signals of SAW touch panel, thereby increasing the sensing accuracy of the SAW touch panel.

According to the present invention, the method for generating driver signals of SAW touch panel includes the steps of: sending a trigger signal continuously by referring to an input signal, wherein the trigger signal is sent when the input signal is within a predetermined range; generating a surface acoustic wave according to the trigger signal; transmitting the surface acoustic wave to at least one transducer via a touch surface; and detecting the input signal via at least one transducer. Moreover, the input signal is kept on a predetermined level when the surface acoustic wave has not been received by the transducer and when a noise signal from circuits outside the transducer has not been added in the input signal. The predetermined level is within the predetermined range.

Furthermore, according to a feature of the present invention, the method for generating driver signals of SAW touch panel comprises a step of detecting an input signal via at least one transducer. A trigger signal is sent continuously by referring to the input signal. Once each of the trigger signals is to be triggered, the trigger signal is sent when the input signal is within a predetermined range.

According to another aspect of the present invention, the apparatus for generating driver signals of SAW touch panel comprises: a detecting circuit having at least one transducer, the detecting circuit detecting an input signal via the at least one transducer; and a control circuit electrically connected to the detecting circuit. The control circuit sends a trigger signal continuously by referring to the input signal. Once each of the trigger signals is to be triggered, the control circuit sends the trigger signal when the input signal is within a predetermined range.

### BRIEF DESCRIPTION OF DRAWING

FIG. 1 is a top view of a conventional SAW touch panel;

FIG. 2 is a perspective view of a conventional SAW touch panel;

FIG. 3 is a view showing the voltage waveform when the SAW touch panel has not been touched by an object;

FIG. 4 is a view showing the voltage waveform when the SAW touch panel has been touched by an object;

FIG. 5 is a flow chart showing the method for generating driver signals of SAW touch panel according to the present invention;

FIG. 6 is a block view showing the apparatus for generating driver signals of SAW touch panel according to the present invention;

FIG. 7 is a view showing the waveform of a SAW signal;

FIG. 8 is a view showing the waveform of a noise signal;

FIG. 9 is a view showing the waveform of a SAW signal added with a noise signal in prior art;

FIG. 10 is a view showing the waveform of a SAW signal added with a noise signal according to the present invention;

FIG. 11 is a view showing the waveform of a SAW signal added with a noise signal according to the present invention;

FIG. 12 is a view showing the waveform of a SAW signal;

FIG. 13 is a view showing the waveform of a noise signal;

FIG. 14 is a view showing the waveform of a SAW signal added with a noise signal in prior art;

FIG. 15 is a view showing the waveform of a SAW signal added with a noise signal according to the present invention; and

FIG. 16 is a view showing the waveform of a SAW signal added with a noise signal according to the present invention.

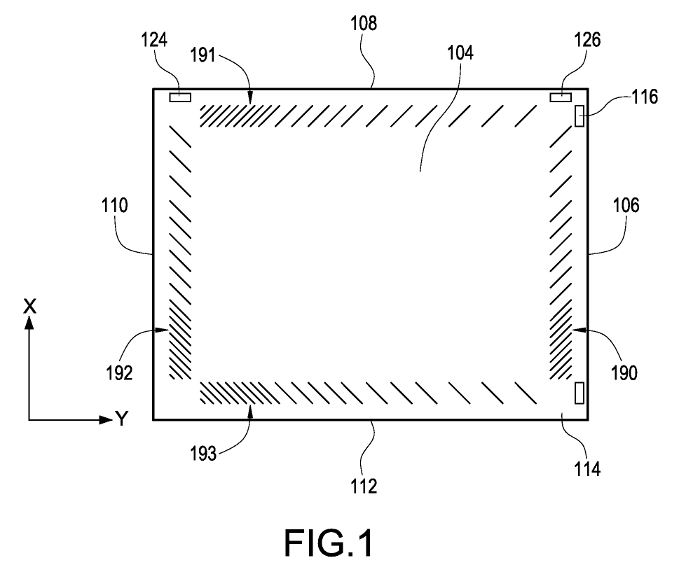

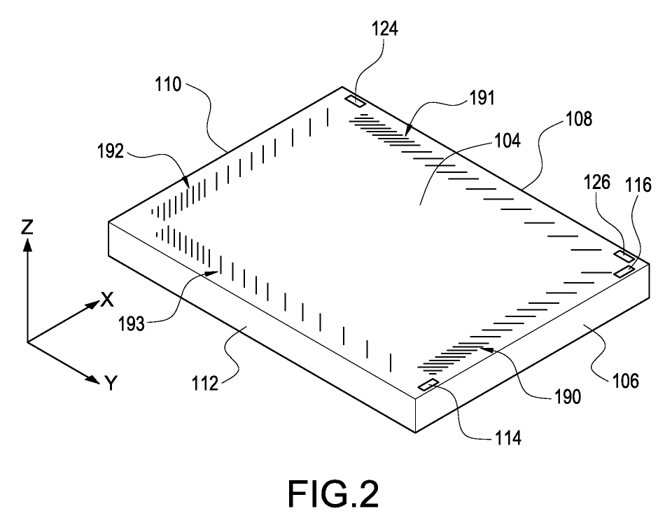

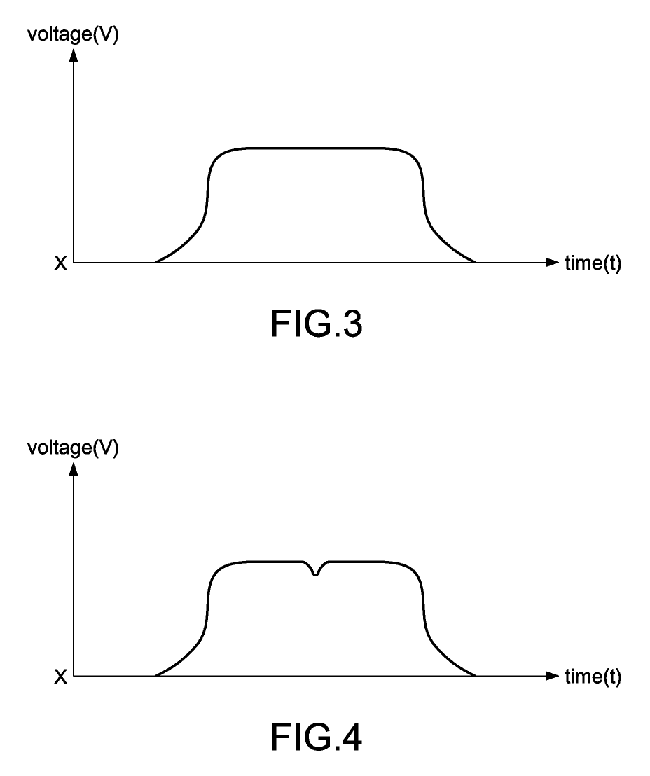

### DETAILED DESCRIPTION OF THE INVENTION

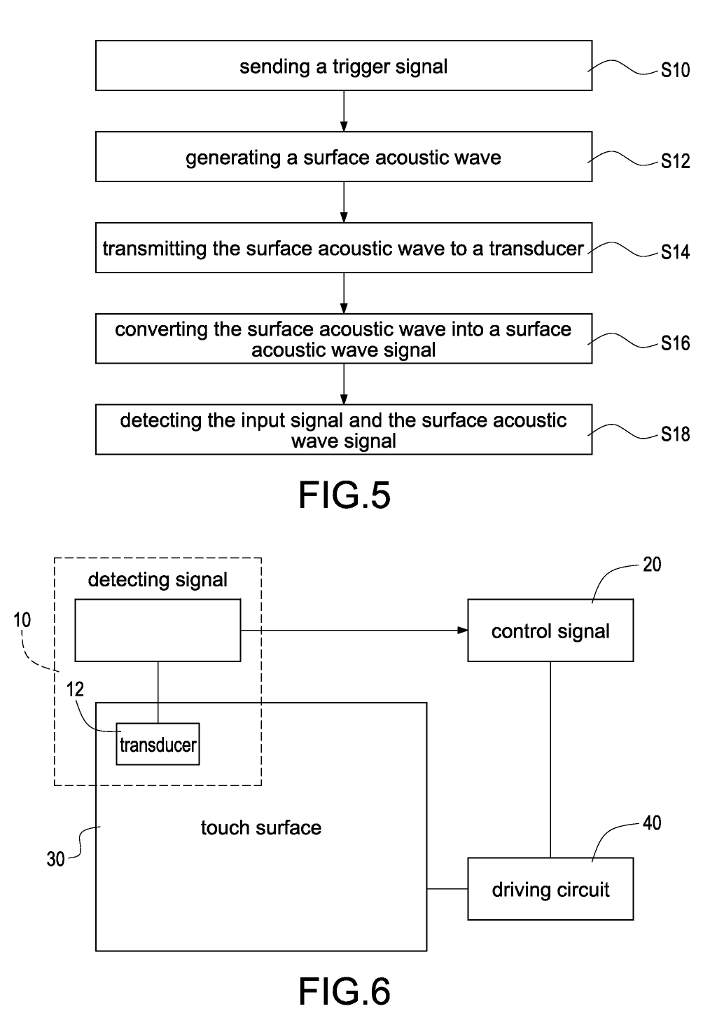

Please refer to FIG. 5, which is a flow chart showing the method for generating driver signals of SAW touch panel according to the present invention. For better understanding, the steps of the present method are described one by one in the following.

First, in step S10, a trigger signal is sent continuously by referring to an input signal. The trigger signal is sent when the input signal is within a predetermined range. That is to say, once the trigger signal is to be sent, the range of the input signal has to be referred. Only when the input signal is within the predetermined range, the trigger signal can be sent. If the input signal is not within the predetermined range, the trigger signal is not sent until the input signal is within the predetermined range. The step S10 is performed by a control circuit.

Next, in step S12, a surface acoustic wave is generated according to the trigger signal. The step S12 is known in prior art and can be performed by a driving circuit. The driving circuit receives the trigger signal emitted from the control circuit, and then converts the mechanical energy into electric energy (and vice versa) via the piezoelectric effect.

Next, in step S14, the surface acoustic wave is transmitted to at least one transducer via a touch surface. The generated surface acoustic wave is transmitted to the transducer via the touch surface.

Finally, in steps S16 and S18, the transducer converts the surface acoustic wave into a surface acoustic wave (SAW) signal, which is added in the input signal. The transducer can detect the input signal. For example, via a detecting circuit, the transducer can detect the input signal. During the period of detecting the input signal via the transducer, the value of the SAW signal can be detected. Via the time difference between the emissions of trigger signals, the position of the SAW signal added in the input signal can be determined. That is, after the transducer receives the surface acoustic wave, the values of the SAW signal can be detected. Further, the input signal is generated and sent to the control circuit. Then, back to the step S10, when the trigger signal is to be sent to the driving circuit, the range of the input signal is referred. If the input signal is not within the predetermined range, the trigger signal is not sent to the driving circuit until the input signal is within the predetermined range. When the SAW signal is added to the noise signal, the waveform may be inclined. Via the calculation of the slope, the original SAW signal can be simulated.

The input signal is kept on a predetermined level when the surface acoustic wave has not been received by the transducer (i.e., since the input signal is not within the predetermined range, the trigger signal is not sent to the driving circuit to generate the surface acoustic wave, and thus the transducer cannot receive the surface acoustic wave) and when a noise signal from circuits outside the transducer has not been added in the input signal. The predetermined level is within the predetermined range. The noise signal may come from any place, and especially the noise signal from a power-supplying circuit is most serious.

The input signal is detected in a detecting range. The difference between the detecting range and the predetermined range is larger than the maximum of the SAW signal. For example, via the detecting circuit, when the transducer detects the input signal, the detecting circuit can only detect the input signals within the detecting range. That is to say, the input signal can be detected only when it is within the detecting range. The input signal beyond the detecting range cannot be detected. Furthermore, the difference between the detecting range and the predetermined range has to be larger than the maximum of the SAW signal. In other words, the predetermined range is within the detecting range, and the difference between the detecting range and the predetermined range has to accommodate the maximum of the SAW signal (the maximum of the SAW signal can be measured in advance). In this way, the SAW signal can be detected completely, and the SAW signal can be correctly detected because the SAW signals are not beyond the detecting range. This will be described in more detail later.

Please refer to FIG. 6, which is a block view showing the apparatus for generating driver signals of SAW touch panel according to the present invention. The apparatus for generating driver signals of SAW touch panel according to the present invention comprises a detecting circuit 10, a control circuit 20, a driving circuit 40 and a touch surface 30. The detecting circuit 10 is electrically connected to the control circuit 20 and the touch surface 30. The driving circuit 40 is electrically connected to the control circuit 20 and the touch surface 30. The detecting circuit 10 further comprises at least one transducer 12.

The control circuit 20 sends a trigger signal continuously by referring to an input signal. Once each of the trigger signals is to be triggered, the control circuit 20 sends the trigger signal when the input signal is within a predetermined range. That is to say, the trigger signal is sent by the control circuit 20 only when the input signal is within the predetermined range. When the control circuit 20 needs to send the trigger signals, it will refer to the range of the input signal. Only when the input signal is within the predetermined range, the control circuit 20 can send the trigger signal. If the input signal is not within the predetermined range, the control circuit 20 will wait for sending the trigger signal until the input signal is within the predetermined range.

The driving circuit 40 generates a surface acoustic wave according to the trigger signal. After the driving circuit 40 receives the trigger signal from the control circuit 20, it converts mechanical energy into electric energy (or vice versa) via the piezoelectric effect, thereby generating the surface acoustic wave. The touch surface 30 allows the transmission of the surface acoustic wave. That is, the touch surface 30 transmits the surface acoustic wave to the transducer 12.

After the transducer 12 receives the surface acoustic wave, it converts the surface acoustic wave into a SAW signal. The SAW signal is added in the input signal. Via the transducer 12, the detecting circuit 10 detects the input signal. During the period of detecting the input signal, the transducer 12 can also detect the value of the SAW signal at the same time. That is, after the transducer 12 receives the surface acoustic wave, the value of the SAW signal can be detected. Further, the input signal is generated and transmitted to the control circuit 20.

The input signal is kept on a predetermined level when the surface acoustic wave has not been received by the transducer 12 (i.e., since the input signal is not within the predetermined range, the control circuit 20 does not send the trigger signal to the driving circuit 40 to generate the surface acoustic wave, and thus the transducer 12 cannot receive the surface acoustic wave) and when a noise signal from circuits outside the transducer has not been added in the input signal. The predetermined level is within the predetermined range. The noise signal may come from any place, and especially the noise signal from a power-supplying circuit is most serious. The input signal is detected within a detecting range. The difference between the detecting range and the predetermined range is larger than the maximum of the SAW signal. This will be described in more detail later.

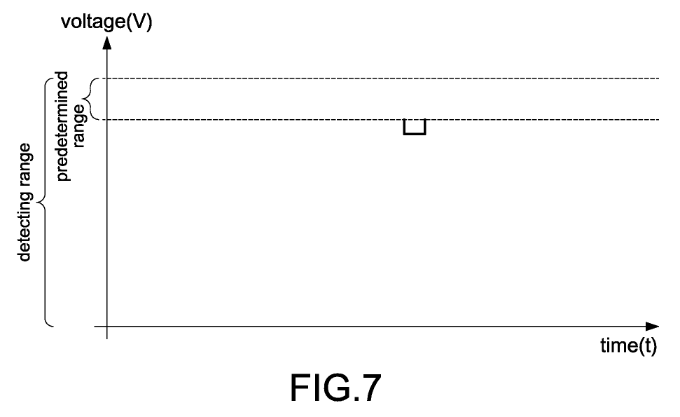

Please refer to FIG. 7, which is a view showing the waveform of the SAW signal and the maximum is defined as 0 volt. The transducer 12 converts the surface acoustic wave into the SAW signal. In the shown example, the control circuit 20 sends the trigger signal at the minimum of the predetermined range. Thus, the detected SAW signal is located at the minimum of the predetermined range. The SAW signal is a pulse wave.

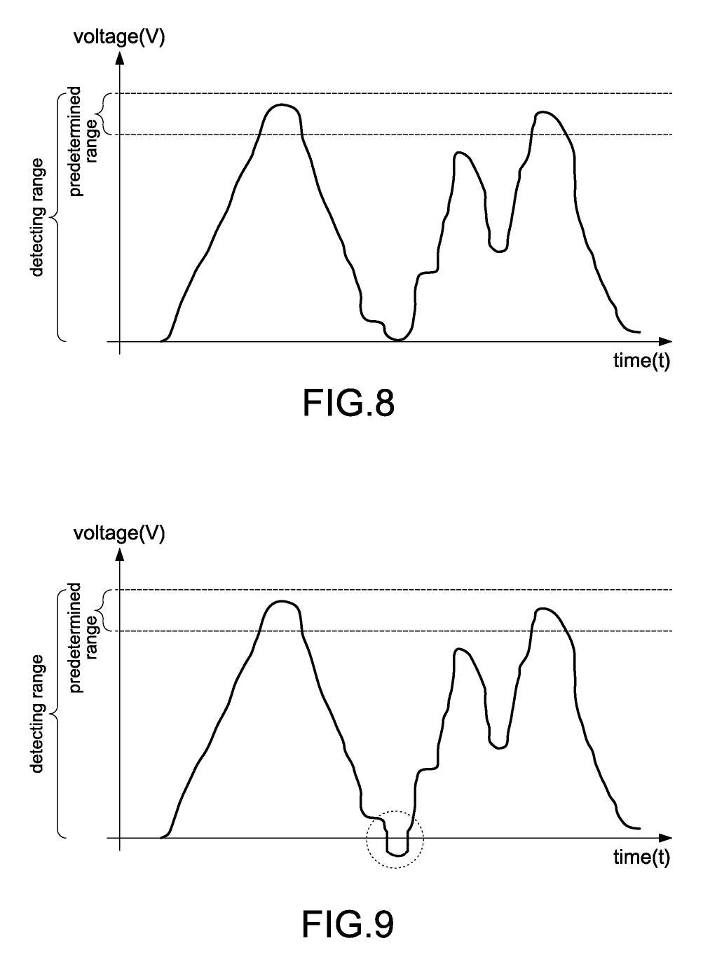

Please refer to FIG. 8, which is a view showing the voltage waveform of a noise signal and the maximum is defined as 0 volt. The noise signal may come from any place, and especially the noise signal from a power-supplying circuit is most serious.

Please refer to FIG. 9, which is a view showing the voltage waveform of the SAW signal added to the noise signal in prior art. In FIG. 9, the maximum is also defined 0 volt. In prior art, without the control the present method, the trigger signal is thus not sent (i.e. the trigger signal is sent when the input signal is not within the predetermined range), so that the SAW signal may exist at any position on the voltage waveform of the noise signal, as shown in the dotted circle in FIG. 9. Since the input signal added with the SAW signal is beyond the detecting range, the SAW signal cannot be determined correctly. As a result, the location of the SAW touch panel cannot be determined correctly.

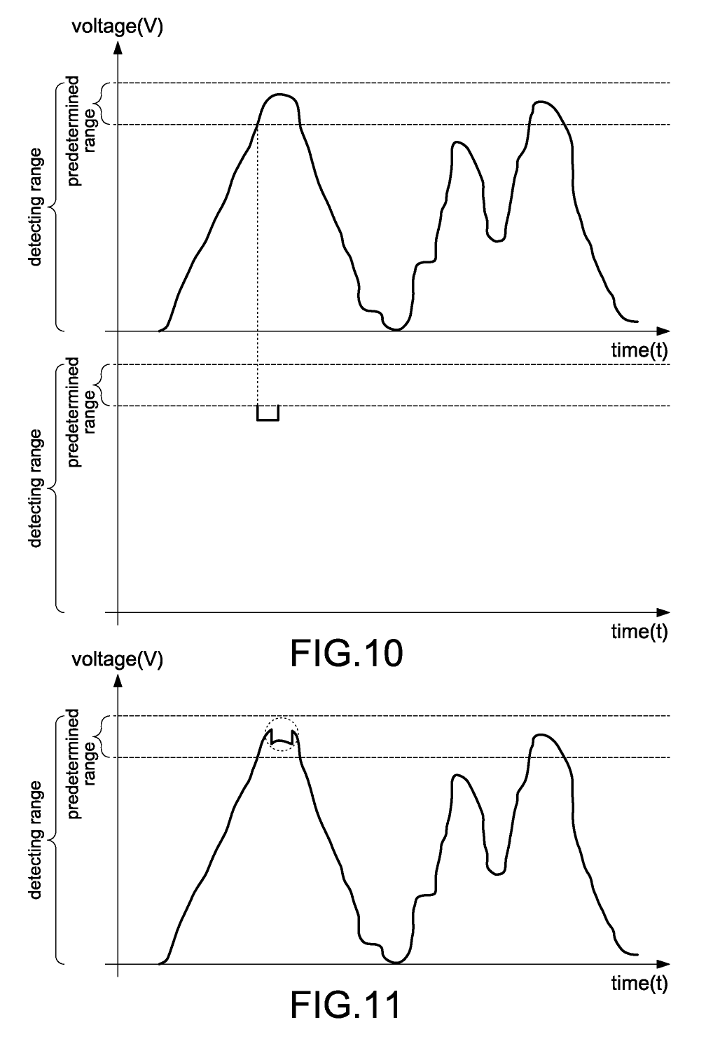

Please refer to FIG. 10, which is a view showing the voltage waveform of the SAW signal added with the noise signal according to the present invention. FIG. 10 shows that the maximum is 0 volt. Please also refer to FIG. 11, which is a view showing the voltage waveform of the SAW signal added with the noise signal according to the present invention. In FIG. 11, the maximum is also defined as 0 volt. Via the control of the present method, the trigger signal is sent (the trigger signal is sent when the input signal is within the predetermined range), as shown by the dotted circle. Since there is a time difference between the emission of the trigger signal and the detection of the SAW signal, the generated waveform will shift rightwards slightly. The potential level of the SAW signal is accurate without being affected by the voltage interference of the noise signal, so that the location of the SAW touch panel to be touche can be determined correctly.

It can be seen from FIGS. 7 to 11 that: the input signal is detected within the detecting range, and the difference between the detecting range and the predetermined range is larger than the maximum of the SAW signal. That is, only the input signal within the detecting range can be detected. The input signal beyond the detecting range cannot be detected. Furthermore, the difference between the detecting range and the predetermined range has to be larger than the maximum of the SAW signal. In this way, the SAW signal can be detected completely and certainly. The SAW signal will not fail to be detected due to the fact that it is beyond the detecting range.

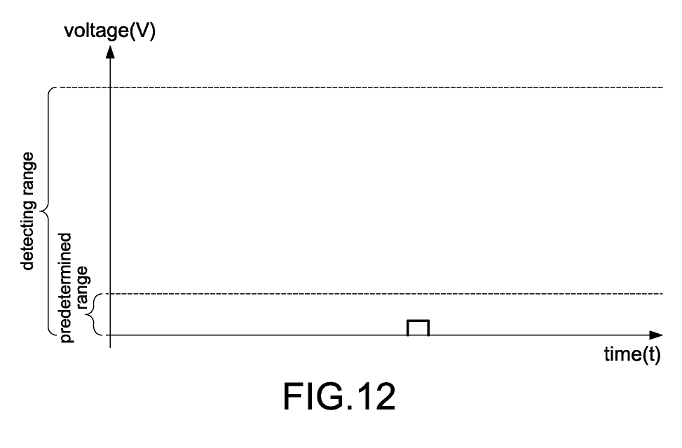

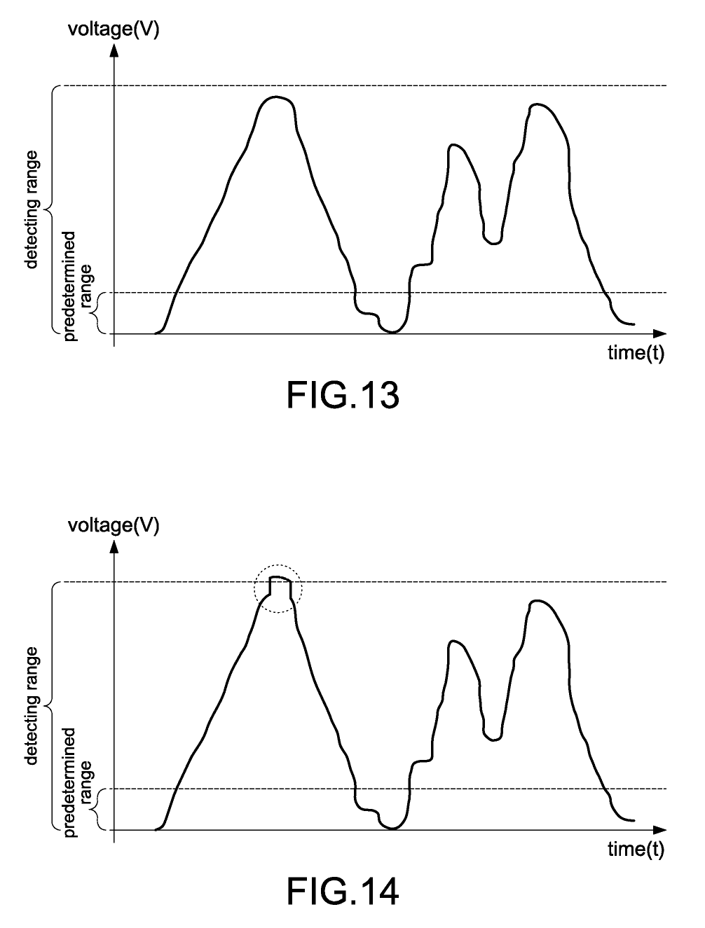

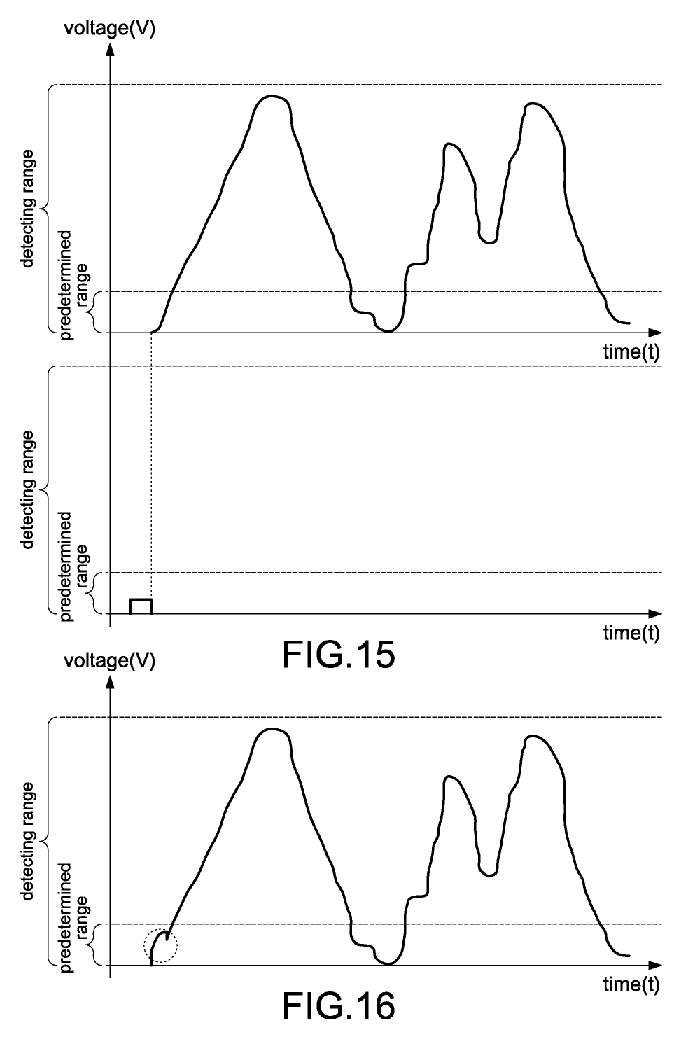

Please refer to FIGS. 12 to 16, which correspond to FIGS. 7 to 11 respectively. However, FIGS. 12 to 16 show waveforms with the minimum defined as 0 volt, and thus the description thereof is omitted for clarity. It can be contemplated by those skilled in this art that the maximum or minimum is not limited to 0 volt and may be other values.

The method and apparatus for generating driver signals of SAW touch panel according to the present invention is characterized in that: when the trigger signal is sent to generate the surface acoustic wave, the magnitude of the input signal has to be referred. If the input signal is within the predetermined range, the voltage of the noise signal existing in the input signal is smaller. The potential level of the SAW signal detected from the thus-generated surface acoustic wave is accurate without being affected by the voltage interference of the noise signal. Thus, the location of the SAW touch panel to be touched can be determined accurately.

According to the above, the present invention really demonstrates industrial applicability, novelty and inventive steps. Further, the structure of the present invention has not been seen in products of the same kind or used in public. Thus, the present invention conforms to the requirements for an invention patent.

What is claimed is:

1. A method for generating driver signals of SAW touch panel, comprising the steps of:
sending a trigger signal continuously by referring to an input signal, wherein the trigger signal is sent when the input signal is within a predetermined range;
generating a surface acoustic wave according to the trigger signal;
transmitting the surface acoustic wave to at least one transducer via a touch surface; and
detecting the input signal via at least one transducer,
wherein the input signal is kept on a predetermined level when the surface acoustic wave has not been received by the transducer and when a noise signal from circuits outside the transducer has not been added in the input signal, and
wherein the predetermined level is within the predetermined range.

2. The method for generating driver signals of SAW touch panel according to claim 1, further comprising a step of detecting the value of a surface acoustic wave (SAW) signal during the period of detecting the input signal via the transducer.

3. The method for generating driver signals of SAW touch panel according to claim 1, wherein the noise signal comes from a power-supplying circuit.

4. The method for generating driver signals of SAW touch panel according to claim 1, wherein the transducer converts the surface acoustic wave into a SAW signal, and the SAW signal is added to the input signal.

5. The method for generating driver signals of SAW touch panel according to claim 4, wherein the input signal is detected within a detecting range, the difference between the detecting range and the predetermined range is larger than the maximum of the SAW signal.

6. A apparatus for generating driver signals of SAW touch panel, comprising:
a detecting circuit having at least one transducer, the detecting circuit detecting an input signal via the at least one transducer; and
a control circuit electrically connected to the detecting circuit,
wherein the control circuit is adapted to send a trigger signal continuously by referring to the input signal, once each of the trigger signals is to be triggered, the control circuit is adapted to send the trigger signal when the input signal is within a predetermined range.

7. The apparatus for generating driver signals of SAW touch panel according to claim 6, further comprising:
a driving circuit electrically connected to the control circuit, the driving circuit generating a surface acoustic wave according to the trigger signal; and
a touch surface electrically connected to the driving circuit, the touch surface allowing the surface acoustic wave to be transmitted;
wherein the detecting circuit detects the value of a SAW signal during the period of detecting the input signal via the transducer.

8. The apparatus for generating driver signals of SAW touch panel according to claim 7, wherein the input signal is kept on a predetermined level when the surface acoustic wave has not been received by the transducer and when a noise signal from circuits outside the transducer has not been added in the input signal.

9. The apparatus for generating driver signals of SAW touch panel according to claim 8, wherein the predetermined range comprises the predetermined level.

10. The apparatus for generating driver signals of SAW touch panel according to claim 8, wherein the noise signal comes from a power-supplying circuit.

11. The apparatus for generating driver signals of SAW touch panel according to claim 6, wherein the transducer converts the surface acoustic wave into a SAW signal, and the SAW signal is added in the input signal.

12. The apparatus for generating driver signals of SAW touch panel according to claim 11, wherein the input signal is detected within a detecting range, the difference between the detecting range and the predetermined range is larger than the maximum of the SAW signal.

13. A method for generating driver signals of SAW touch panel, comprising the steps of:
detecting an input signal via at least one transducer; and
sending a trigger signal continuously by referring to the input signal,
wherein once each of the trigger signals is to be triggered, the trigger signal is sent when the input signal is within a predetermined range.

14. The method for generating driver signals of SAW touch panel according to claim 13, further comprising the steps of:
generating a surface acoustic wave according to the trigger signal; and
transmitting the surface acoustic wave to the transducer via a touch surface.

15. The method for generating driver signals of SAW touch panel according to claim 14, further comprising a step of detecting the value of a SAW signal during the period of detecting the input signal via the transducer.

16. The method for generating driver signals of SAW touch panel according to claim 14, wherein the input signal is kept on a predetermined level when the surface acoustic wave has not been received by the transducer and when a noise signal from circuits outside the transducer has not been added in the input signal.

17. The method for generating driver signals of SAW touch panel according to claim 16, wherein the predetermined range comprises the predetermined level.

18. The method for generating driver signals of SAW touch panel according to claim 16, wherein the noise signal comes from a power-supplying circuit.

19. The method for generating driver signals of SAW touch panel according to claim 13, wherein the transducer converts the surface acoustic wave into a SAW signal, and the SAW signal is added in the input signal.

20. The method for generating driver signals of SAW touch panel according to claim 19, wherein the input signal is detected within a detecting range, the difference between the detecting range and the predetermined range is larger than the maximum of the SAW signal.
